(19) United States
(12) Patent Application Publication
(10) Pub. No.: US 2008/0038634 A1
(43) Pub. Date: Feb. 14, 2008

(54) High Capacity Alkaline Cell Utilizing Cathode Extender

(75) Inventors: William C. Bushong, Madison, WI (US); Paul Cheeseman, Verona, WI (US); Gregory J. Davidson, Oregon, WI (US); Zihong Jin, Cottage Grove, WI (US); Erik Mortensen, Sun Prairie, WI (US); Ernest Ndzebet, Madison, WI (US); Karthik Ramaswami, Middleton, WI (US); Viet H. Vu, Verona, WI (US)

Correspondence Address: Christopher M. Goff (27840);ARMSTRONG TEASDALE LLP, ONE METROPOLITAN SQUARE, SUITE 2600, ST. LOUIS, MO, 63102, US

(73) Assignee: Rovcal, Inc., Madison, WI (US)

(21) Appl. No.: 10/582,193

(22) PCT Filed: Dec. 10, 2004
(86) PCT No.: PCT/US04/41484

§ 371 Date: May 9, 2007

Related U.S. Application Data
(60) Provisional application No. 60/528,414, filed on Dec. 10, 2003.

(51) Int. Cl. H01M 4/48; H01M 4/62

(52) U.S. Cl. 429/206; 429/210

(57) ABSTRACT

An electrochemical cell is provided that includes a container, a cathode and anode disposed in the container, and a separator disposed between the anode and cathode. The cell further includes an extender either included in or separate from the cathode. An agent is further provided that interacts with soluble ionic species generated in the cathode to prevent the migration of the species to the anode.

### CROSS REFERENCE TO RELATED APPLICATIONS

This application claims the benefit of U.S. Provisional Patent Application No. 60/528,414 filed Dec. 10, 2003, the disclosure of which is incorporated by reference as if set forth in its entirety herein.

### STATEMENT REGARDING FEDERALLY SPONSORED RESEARCH OR DEVELOPMENT

Not applicable.

### BACKGROUND

The market for consumer alkaline batteries continues to demand standard size cells having higher capacity to support longer run times for battery-operated devices. The discharge efficiencies of the conventional alkaline Zn anode/MnO₂ cathode battery are reaching their limits due to the electrochemical capacity of the materials used. The present invention relates to alkaline cells having higher capacity than has heretofore been possible in a conventional alkaline Zn/MnO₂ battery. Whereas a conventional alkaline cell typically contains a single cathode active material (for example MnO₂), cells constructed in accordance with certain aspects of the invention contain a primary cathode active material and a cathode extender material. The cells, in accordance with certain aspects of the invention, are characterized by a higher cell capacity balance than can be employed in conventional alkaline cells that lack a cathode extender. The cell balance can be expressed as a ratio between the capacity of the anode active material and the capacity of the primary cathode active material (henceforth, the anode: primary cathode capacity ratio).

Proper cell balance is desirable for several reasons. Electrochemical current is generated in a battery via reductive and oxidative half-reactions. Every electron released during oxidation of anode active material is consumed during reduction of cathode active material. The fact that these two half-reactions must proceed allows cells to be designed such that one half-cell reaction can limit the total cell discharge capacity. As such, if one electrode active material is provided in electrochemical excess while the other is provided in an electrochemically limiting amount, substantially all of the limiting active material is consumed by end of discharge while some non-limiting active material remains unconsumed. This unconsumed active material represents a wasteful cost, considering the billions of batteries made and sold each year.

Nevertheless, for most battery system designs it is common practice for reasons of safety to deliberately limit the amount of active material in one electrode, so that none of that material remains after cell discharge. For example, primary lithium batteries are designed to ensure almost complete lithium consumption to avoid fire or explosive hazards that could result from inappropriate disposal of “apparently dead” batteries containing residual lithium.

Likewise, in alkaline batteries that contain residual electrode and/or electrolyte, decomposition of electrolyte and water on over-discharge can generate H₂ or O₂ gas in quantities sufficient to raise internal cell pressure to a level that can exceed the rupture pressure of the battery seal and can lead undesirably to cell bulging, venting, leakage, or rupture. The amount of residual water available for reduction-oxidation reactions after the cell has exhausted the designed capacity is an important design parameter. Upon over-discharge of a cathode-limited cell (i.e., one that contains excess anode), when the voltage of the cathode goes to a low enough value, water in the electrolyte will be reduced and hydrogen gas evolved in a reaction (4H₂O+4e→2H₂+4OH⁻) that can proceed at the cathode surface until the excess liquid or anode is exhausted. Similarly, in an anode-limited cell, when the anode potential exceeds the electrochemical threshold for oxygen evolution, the available hydroxide will be oxidized (4OH⁻→O₂+2H₂O+4e⁻) at the anode surface and evolve oxygen gas. If both reactions occur simultaneously, gas can evolve from both electrodes.

For a good battery design, it is desirable that the anode is the limiting electrode, because in such an anode-limited cell the number of moles of gas generated per electron transferred would be less than in an equivalent cathode-limited cell. In the anode-limited cell, when the anode material is substantially exhausted, further electron transfer decomposes electrolyte and water to generate only one mole of oxygen, whereas transfer of the same number of electrons in a cathode-limited cell generates two moles of hydrogen as seen from the equations above. Since the molar volumes of hydrogen and oxygen are comparable at comparable temperature and pressure, electrolyte gassing generates only about half the internal pressure in an anode-limited cell as in a cathode-limited cell. In this condition, anode voltage increases rapidly before the cathode voltage can drop to a level sufficiently low to generate hydrogen gas, as illustrated schematically in FIG. 1A.

The cell void volume and the seal vent pressure are designed to accept the increased pressure without leakage or rupture, based on the amount of electrolyte estimated to remain in the cell at the end of discharge. The skilled artisan also understands that the electrolyte concentration and relative amounts of electrolyte and electrode are also important cell design factors that can be optimized as desired. In commercial cells having a conventional zinc anode and a conventional manganese dioxide cathode, the anode: cathode capacity ratio is lower than about about 1:1, but can range from about 0.90 to about 1.0. Use of ratios above about 0.98:1 is risky and rarely, if ever, seen in commercial product. Furthermore, at an anode:cathode capacity ratio above about 1:1, there is a high risk that the cathode voltage can drop precipitously upon over-discharge to a voltage below the hydrogen evolution electrochemical threshold and the residual electrolyte can decompose, leading to gassing and potentially to cell rupture. A similar situation can arise just during over-discharge of the cell when voltage reversal occurs in a series string of cells where one cell is exhausted prior to the others in the string and current is therefore still passing through the string.

Cell gassing is not the only issue that faces alkaline cells having an anode:MnO₂ capacity ratio greater than about 1:1. It is well known that the manganese dioxide cathode shows higher discharge efficiency to a fixed voltage cut-off, if presented with generous quantities of electrolyte. At the conventional capacity ratio (below 1:1), a lack of sufficient anode and electrolyte hampers cathode utilization and permits only a small fraction of the available discharge capacity of the MnO₂ to be extracted above the typical cut-off voltage for most devices. {FIG. 2 compares the cathode discharge in a practical cell vs. one that has unlimited (ideal) supply of electrolyte available.} Accordingly, a practical cell designed for better cathode utilization without increasing the potential for significant gassing would have higher cell capacity than is possible today. However, in view of the current physical design constraints, the only known ways to significantly improve the discharge capacity of alkaline consumer round cells are either to use higher-efficiency active materials or to use other, higher-capacity active materials.

It is therefore desired to improve the discharge efficiency of alkaline batteries by providing an electrochemical cell that contains more anode than conventionally achieved (thus also providing more electrolyte) than a conventional alkaline battery without the problem of excessive gassing.

### SUMMARY

In accordance with one aspect of the invention, an electrochemical cell includes a container, and a cathode disposed in the container. The cathode includes a primary active material. The cell further includes an extender that is different from the primary active material and present in an amount no greater than that of the primary active material. An anode including an anode material is disposed in the container adjacent the cathode. At least one separator is disposed between the anode and cathode, and further disposed between the anode and extender.

In accordance with another aspect of the invention, an electrochemical cell includes a container, and a cathode disposed in the container. The cathode includes a primary active material. The cell further includes an extender that is different from the primary active material. The extender has a discharge voltage lower than an initial discharge voltage of the primary active material. An anode including an anode material is disposed in the container adjacent the cathode. At least one separator is disposed between the anode and cathode, and further disposed between the anode and extender.

In accordance with yet another aspect of the invention, a method is provided for producing an electrochemical cell. The method includes the steps of providing a cell container; placing a cathode in the container, wherein the cathode comprises a primary active material; placing an extender in the container, the extender different from the primary active material and present in an amount no greater than that of the primary active material; placing an anode in the container; and providing at least one separator between the anode and both of the cathode and the extender.

In accordance with still another aspect of the invention, a method is provided for producing an electrochemical cell. The method includes the steps of providing a cell container; placing a cathode in the container, wherein the cathode comprises a primary active material; placing an extender in the container, wherein the extender is different from the primary active material and has a discharge voltage lower than an initial discharge voltage of the primary active material; placing an anode in the container; and providing at least one separator between the anode and both of the cathode and the extender.

In accordance with one version of the invention, an electrochemical cell includes an anode, a cathode, and a separator disposed between the anode and the cathode. The anode has a capacity of at least 0.5 Ah per cubic centimeter of cell internal volume.

In accordance with another version of the invention, an electrochemical cell includes an anode, a cathode comprising a manganese oxide, an extender, and at least one separator disposed between the anode and both the cathode and the extender.

In accordance with still another version of the invention, a cathode usable in an electrochemical cell includes a primary active material, and an extender different from the primary active material and present in an amount no greater than that of the primary active material.

In accordance with yet another version of the invention, a cathode usable in an electrochemical cell includes a primary active material comprising a manganese oxide, and an extender.

In accordance with another facet of the invention, an extender is provided that is usable in combination with a cathode of an electrochemical cell where the cathode includes a primary active material. The extender is different than the primary active material and present in an amount no greater than that of the primary active material.

In accordance with yet another facet of the invention, an electrochemical cell includes an anode, a cathode, and a separator disposed between the anode and the cathode. At least a portion of the cathode is identified generally by MₓCu_{y}O_{z}, wherein “M” is any element capable of producing mixed oxide compounds or complexes.

Other aspects and advantages will become apparent, and a fuller appreciation of specific adaptations, compositional variations, and physical attributes will be gained upon an examination of the following detailed description of the various embodiments, taken in conjunction with the appended claims.

### BRIEF DESCRIPTION OF THE DRAWINGS

FIG. 1A schematically illustrates the regions of gas evolution by a conventional anode-limited cell;

FIG. 1B schematically illustrates the regions of gas evolution by a cell constructed in accordance with certain aspects of the present invention;

FIG. 2 illustrates a graph comparing the cathode discharge voltage vs. discharge efficiency in a practical cell vs. a half-cell that has unlimited (ideal) electrolyte available (simulating an unlimited anode capacity);

FIG. 3 illustrates a sectional side elevation view of a cylindrical electrochemical cell;

FIG. 4 schematically illustrates the electrochemical balance of a conventional cell and a cell including an extender in accordance with one aspect of the present invention;

FIG. 5 illustrates a plurality of configurations for a flat electrochemical cell;

FIG. 6 illustrates a plurality of configurations for an electrochemical cylindrical cell;

FIG. 7A illustrates an alternative configuration for a cylindrical electrochemical cell where the extender is separate from the primary cathode material and disposed in tablets in various locations within the cell;

FIG. 7B illustrates a plurality of alternative configurations for an electrochemical cell;

FIG. 8 illustrates another alternative configuration for a cylindrical electrochemical cylindrical cell where the extender is separate from the primary cathode material and disposed proximal to the positive cell terminal;

FIG. 9A illustrates a sectional side elevation view of a cylindrical electrochemical cell including an extender material disposed adjacent the inner surface of the cell container;

FIG. 9B illustrates a sectional side elevation view of a cylindrical electrochemical cell similar to FIG. 9A, but with the extender positioned in accordance with an alternative embodiment;

FIG. 9C illustrates a sectional side elevation view of a cylindrical electrochemical cell similar to FIG. 9B, but with the extender positioned in accordance with another alternative embodiment;

FIG. 10 is a graph showing the continuous discharge behavior at 12.5 mA (250 mA Equivalent AA) of alkaline cells having various anode/primary cathode capacity ratios and 90% EMD/10% jet-milled CuO (extender) compared to an all-EMD conventional AA cell, showing the extender effect in accordance with aspects of the present invention.

FIG. 11 is a graph similar to FIG. 10, but with the discharge behavior of the cells at 5 mA (100 mA equivalent AA) current;

FIG. 12 illustrates the anode and cathode discharge voltages of a LR6 (AA) cell having a conventional anode: primary cathode capacity ratio plotted vs. a Hg/HgO reference electrode provided in the cell;

FIG. 13 illustrates the anode and cathode discharge voltages vs. a Hg/HgO reference electrode, of an LR6 (AA) cell having excess anode (i.e., an anode: primary cathode capacity ratio of approximately 1.2:1); and

FIG. 14 illustrates the anode and cathode discharge voltages vs. a reference electrode, of an LR6 (AA) cell including a cathode extender in accordance with certain aspects of the present invention.

### DESCRIPTION

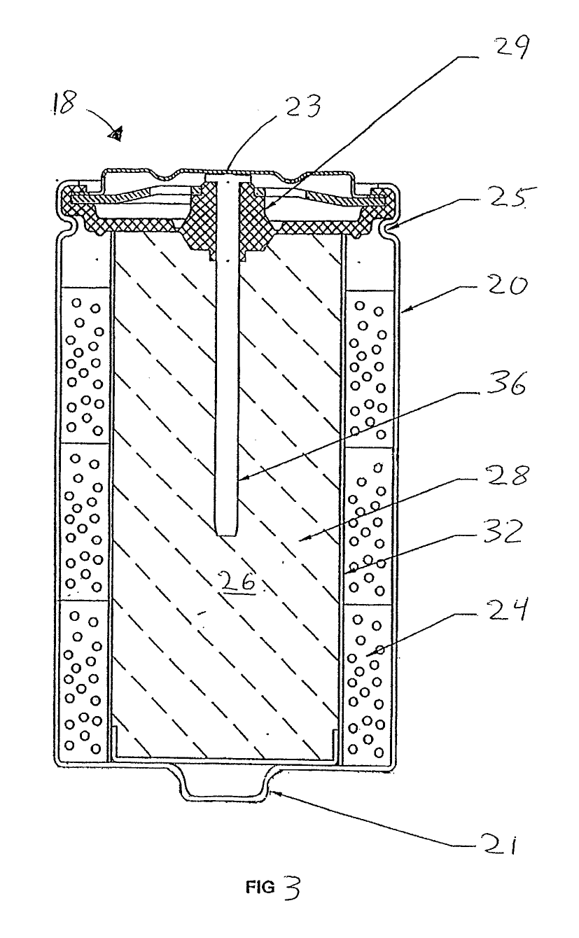

The present invention relates to electrochemical cells, for example alkaline electrochemical cells and their component parts. Certain aspects of the invention can be applicable to any electrochemical system that currently requires a certain anode:cathode capacity balance for reasons of performance and/or reliability. A conventional cylindrical alkaline electrochemical cell is illustrated in FIG. 3, though a skilled artisan will appreciate that the present invention is not limited to the cell illustrated, but rather applies to other cylindrical cell configurations and other non-cylindrical cells, such as flat cells (prismatic cells and button cells).

Referring to FIG. 3, an axially extending primary alkaline cylindrical cell 18 includes a positive current collector 20, which is a drawn steel container that is about 0.012 inches thick and initially open at one end and closed at one end. One or more annular cathode rings 24, formed by application of pressure to a cathode mix to produce a cathode matrix in the form of a plurality of rings, such that their outside diameters at their outer peripheral sidewalls are greater than the inside diameter of the positive current collector 20 are placed into the positive current collector 20, forming a pressure contact with the positive current collector 20. The cathode rings 24 present an inner surface that defines a centrally shaped void that provides an anode compartment 28. A separator 32 and an anode 26 that can include gelled zinc are placed inside the void defined by the cathode rings 24, with the inner surface of the cathode rings 24 and an outer surface of the anode 26 engaging the separator 32. A sealing disk 29 having a negative current collector 36 extending therethrough is placed into the open end of the container and in contact with a bead 25 that is rolled into the container near the open end to support the sealing disk 29. The open end of the container 20 is crimped over the sealing disk 29 thus compressing the sealing disk 29 between the crimped open end and the bead 25 to close and seal the cell 18. Positive current collector defines an outwardly extending nubbin 21.

The separator 32 is substantially cylindrical, and includes an ionically permeable material and is interposed between the anode 26 and the inner peripheral sidewalls of the cathode rings 24 to prevent electrical contact between the anode 26 and the cathode 24 while permitting ionic transport between the anode 26 and the cathode 24. The separator 32 further extends radially across the flat surface of the cell 18, proximal the positive terminal end and between the inner surface of the can 22 and the anode 26. This portion of the separator 32 may be integral to the cylindrical separator 32, or, as is common in the art, may be in the form of a separate “bottom cup” comprising similar but often thicker material as illustrated in FIG. 3. An alkaline aqueous electrolyte typically including potassium hydroxide and water at least partially wets the anode 26, the cathode rings 24, and the separator 32. The cell 18 illustrated in FIG. 3 is not intended to limit the present invention, but rather to provide one example of an electrochemical cell that may be used to practice the present invention, it being appreciated that several other cell constructions could alternatively be used, including cell constructions wherein one or more of the alkaline electrolyte concentration, anodic zinc packing level, and anodic zinc particle size distribution, are altered to achieve a performance benefit. Although a cylindrical cell is shown, the invention may be applied equally well to any electrochemical cell design, without regard to size or shape, including, but not limited to, sizes AA, AAA, C, D, 9V, and button and prismatic cells.

The cathode 24 includes a cathode active material, which can be manganese dioxide. The manganese dioxide can be electrolytic manganese dioxide (EMD). Accordingly, as EMD is added to the cathode mix, the discharge capacity of the cell 18 is correspondingly increased. It should be appreciated that chemical manganese dioxide (CMD) or natural manganese dioxide (NMD) may be alternatively used instead of or concurrently with EMD. Accordingly, the term manganese dioxide as used throughout this disclosure refers to EMD, CMD, NMD, or a combination thereof. It should further be appreciated that the manganese dioxide may be purified if desired as is conventional, to minimize impurities which can cause excessive anode gassing.

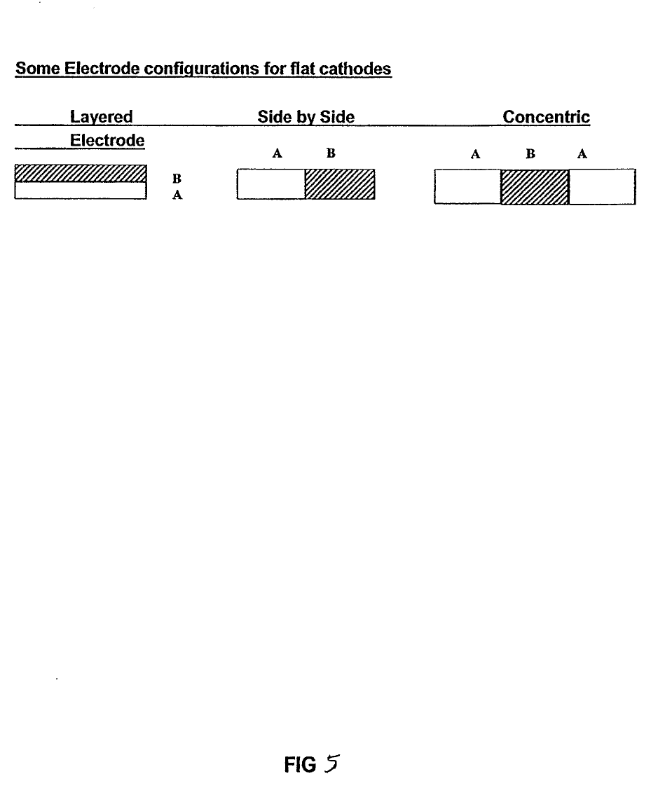

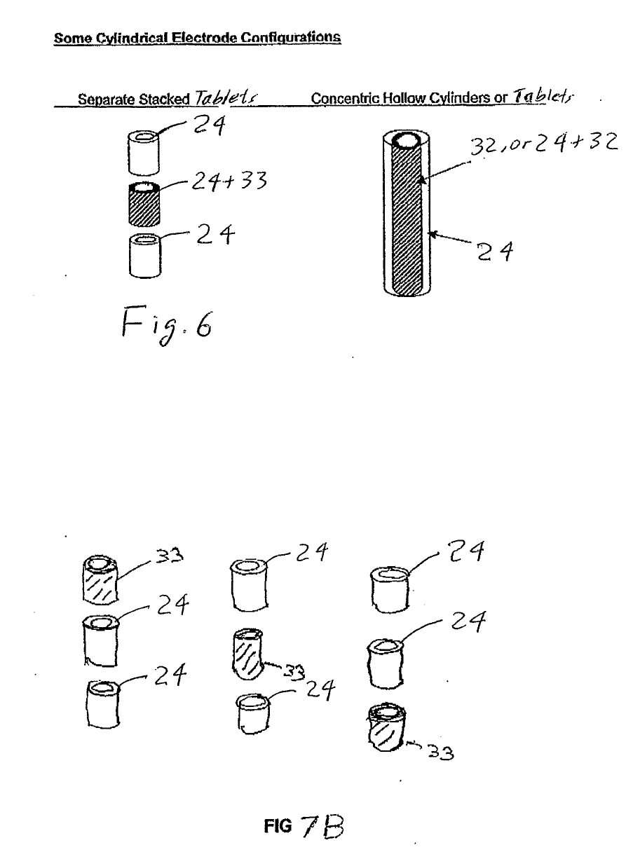

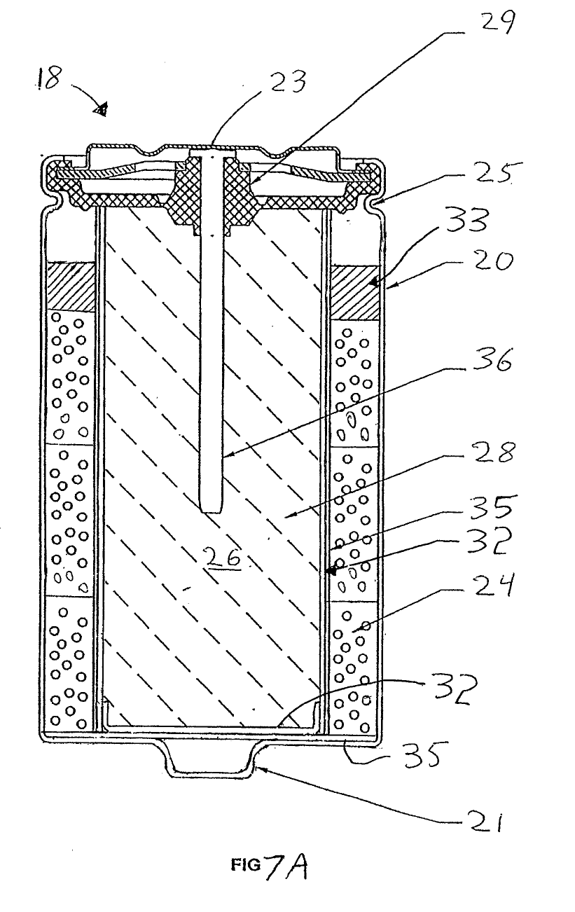

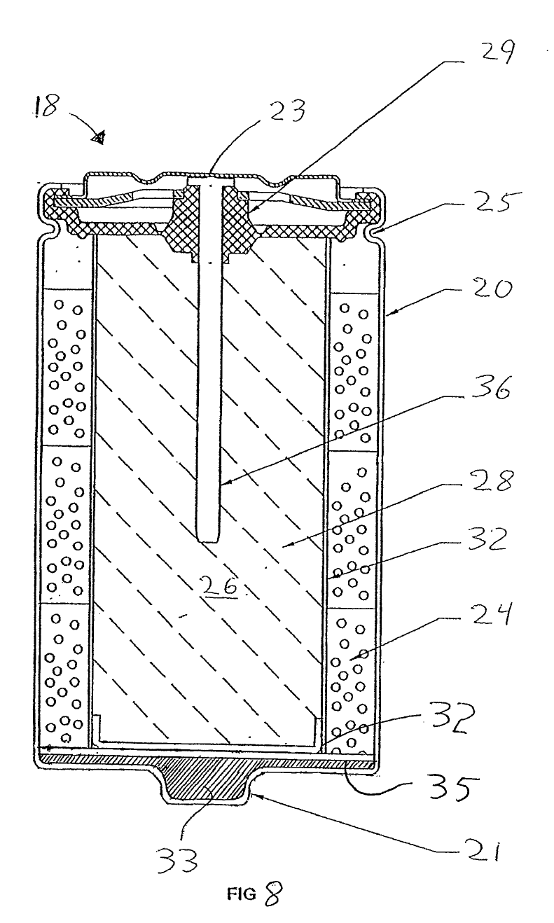

In a broad embodiment, the electrochemical cell 18 includes an electroactive extender material different from the primary cathode active material. Because the extender material is disposed at a location in the cell 18 opposite the anode 26 with respect to the separator 32, and because the extender improves the cell discharge characteristics, the extender material can also be referred to as a cathode extender that can be physically separate from the cathode 24 (FIGS. 5 and 7B) or blended with the cathode 24 (FIG. 6), as will be described in more detail below.

Non-limiting examples of suitable cathode extender materials include single and mixed-metal oxides, sulfides, hydroxides or salts such as CuO, CuS, Cu(OH)₂, Cu₂O, CuF₂, Cu(IO₃)₂, silver oxides, nickel oxyhydroxides and complexes such as copper iodate, copper oxyphosphate or any stable metal complex including those available from mineral sources directly or as synthesized complexes.

Additional non-limiting examples of suitable cathode extender materials in accordance with certain aspects of the present invention are identified generally by the formula MₓCu_{y}O_{z}, where M is any suitable element, as noted, while 1≦x≦5, 1≦y≦5 and 1≦z≦20. Compounds having AMₓCu_{y}O_{z} as general formula (where A can be selected from among, for example, Li, Na, K, Rb, Cs, Ca, Mg, Sr and Ba and mixtures thereof) can also be designed for use as cathode active materials. In certain aspects of the invention, at least one of CuO, Cu(OH)₂₋ and MₓCu_{y}O_{z} are used as the cathode extender.

One example of a process for preparing a mixed oxide cathode extender material involves chemically reducing a mixed solution of metal salts together with a complexing agent and a reducing agent (for example sodium tetra-borohydride (NaBH₄), sodium formate, formic acid, formaldehyde, fumaric acid or hydrazine) to produce a compound containing the metals. A complex compound of the form A_{w}MₓCu_{y} can also be prepared upon addition of a third metal salt as a precursor in this reduction step. The resulting product can be oxidized under acidic conditions with an oxidizing agent (for example hydrogen peroxide, potassium permanganate, potassium persulfate or potassium chlorate) to form a copper based mixed oxide.

For instance, Cu/Mn compounds prepared in this maimer were shown by X-ray diffraction (XRD) analysis to include a mixed copper manganese oxide phase. Although, no ASTM card corresponds to this oxide, its diffraction pattern is similar to that of Cu₂Mn₃O₈. Other compounds such as Cu₂Mn₂O₅ alone or in combination with CuO were also detected when the pH during the oxidation reaction was lowered (i.e., made more acidic) during the oxidation process. Controlling the oxidation conditions can be used to change the structure of the resulting copper based mixed oxide materials. Final composition and degree of crystallinity of these products may be efficaciously controlled. In addition to the mixed oxide phase, the product of the synthesis may also contain other phases including manganese oxides and copper oxides. As is known to one skilled in the art, such low to medium temperature solution based synthesis methods may produce amorphous mixed metal oxide products.

It is also envisioned that oxidation of the Cu/Mn compounds can be carried out in, for example, an alkaline solution or a solution having a neutral pH. Organic or inorganic acid (or base) can be used to adjust the pH of the oxidation solution. Also, the compounds can be first heat treated prior to chemical oxidation. Furthermore, the synthesized mixed copper metal oxide compounds can be heat-treated prior to being mixed with conducting material to form the cathode.

The mixed oxide compounds can also be prepared by known mechanical alloying methods using a high-energy ball mill or by direct high-temperature synthetic methods in a furnace using various starting material like carbonates, nitrates, acetates, and the like. Such metastasis reactions may be readily designed by one skilled in the art to produce high yield reactions with the desired purity for use as an electrochemical cell component. It is further envisioned that MₓCu_{y}O_{z-} or AMₓCu_{y}O_{z}-copper based mixed oxide materials can alternatively be made by co-precipitating a mixture of a mixed metal salt solution followed by heating the precipitate under appropriate conditions.

It should be appreciated that the above-mentioned materials can be provided as either the primary active material or as the extender material to the extent that the discharge voltage of the extender material is lower than the initial discharge voltage of the primary active material. It should also be noted, as one skilled in the art would appreciate, that although copper oxide is denoted here by the common formula CuO, such materials do not inherently have perfect stoichiometry. In other words, copper and oxygen in CuO are not exactly in a 1:1 ratio, but rather the Cu:O ratio typically ranges from about 0.9:1 to about 1.1:1. It is common to find that such materials are obtained over a range of stoichiometric ratios and also prove viable as useful electrode materials over such ranges. This holds true for other electrode materials disclosed herein as well.

One aspect of the invention provides the extender material in the cell in an amount no greater than that of the primary active material. For example, in the case of an alkaline Zn/MnO₂ cell, in place of a cathode in which the active material is 100% EMD, the cathode has substantially the same total weight of active material wherein more than 50% of the material is EMD, the balance being a cathode extender material. The remainder of the cathode components can be those conventional in an alkaline Zn/MnO₂ battery, although one skilled in the art will readily recognize that the proportions may vary depending on the amount and conductive and binding properties of the extender material.

Another aspect of the invention provides a cathode extender material that exhibits a discharge voltage lower than an initial discharge voltage of the primary cathode active material. In the case of an alkaline Zn/MnO₂ cell, the cathode extender material desirably discharges at a voltage lower than the 1st electron of the manganese dioxide reduction.

Another aspect of the present invention provides an extender material that has a high specific discharge energy density (at least as high as that of the primary cathode active material). As known to one having ordinary skill in the art, energy density can be defined as capacity per unit mass (gravimetric energy density), or ampere-hours (Ah) per unit volume (volumetric energy density) with units of mAh/g or Ah/cc respectively. For example, in the case of an alkaline cell with a manganese oxide cathode, the extender material has an energy density of at least about 300 mAh/g or at least 1.5 Ah/cc, such as for example, CuO (674 mAh/g, 4.26 Ah/cc for a two electron discharge), Cu₂O (337 mAh/g) or Cu(IO₃)₂ (902 mAh/g). A high volumetric and a high gravimetric density material is desirable in certain aspects of the invention, since this permits a small amount of the extender to have a desired impact on the discharge behavior and capacity without occupying too much volume within the cell. For example, the extender occupies less than about 30% of the cathode volume in accordance with certain aspects of the invention.

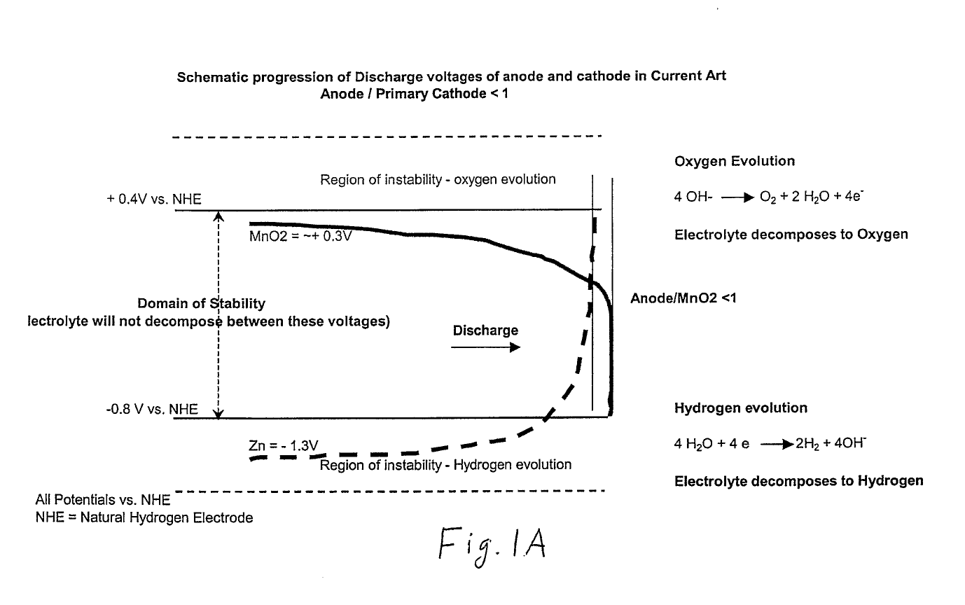

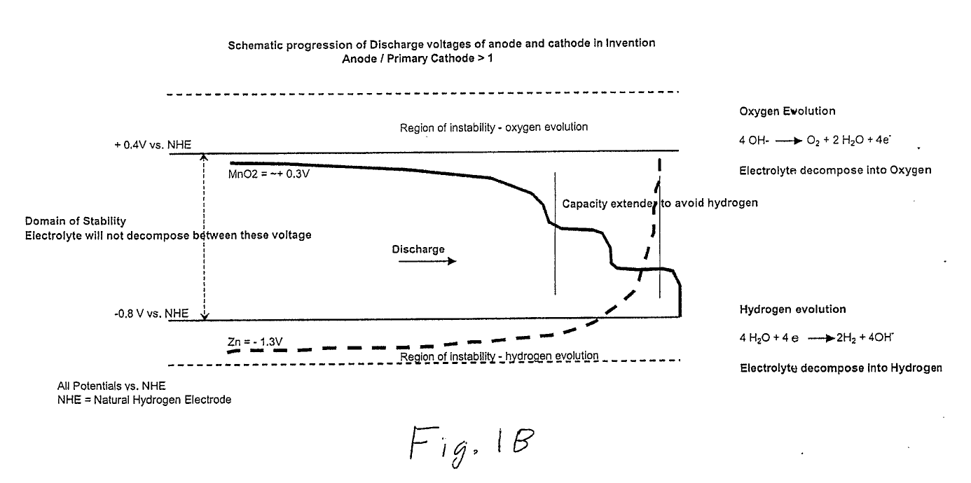

Another aspect of the present invention provides a cell including an extender material that achieves an anode/primary cathode capacity ratio greater than 1:1. The extender material has a substantially flat and stable discharge voltage profile as in the case of a copper oxide or copper hydroxide extender. FIG. 1B shows the anode and cathode voltage profiles of a cell where the anode/primary cathode capacity ratio is greater than 1.0 and the cathode contains a CuO extender material. It should be appreciated that if there is adequate anode for discharge, the CuO will discharge in the following two steps.

Step 1: 2CuO+2e+H₂O→Cu₂O+2OH⁻

Step 2: Cu₂O+2e+H₂O→2Cu+2OH⁻

Furthermore, an electrochemical cell including an extender, in accordance with further aspects of the present invention, has an anode capacity/cell internal volume ratio within a range defined at its lower end by 0.5 Ah/cc or, alternatively 0.55 Ah/cc, and at its upper end by 0.9 Ah/cc or, alternatively 1.0 Ah/cc. The cathode extender material allows the cathode to continue to discharge until substantially all of the excess anode and electrolyte is consumed, such that insufficient residual electrolyte remains to cause excessive gassing. Current commercial alkaline cells are restricted to an anode capacity/internal cell volume ratio of approximately 0.5 Ah/cc based on a zinc capacity of 820 mAh/g and an MnO₂ capacity of 400 mAh/g assuming a 1.33 electron reduction of MnO₂.

In the case of a Zinc/manganese dioxide cell, the cathode extender allows significant new design flexibility where the anode to primary cathode capacity ratio is within a range defined at its lower end that is between and includes 0.98:1, 1:1, 1.03:1, 1.05:1 and, alternatively 1.1:1, and at its upper end by 1.5:1 thereby significantly increasing the discharge capacity of such cells in the usable discharge voltage range of many devices (i.e., above 0.8V) and extending the discharge at discharge voltages below about 0.8V (depending on discharge current), thereby preventing the hydrogen evolution that would normally occur upon over-discharge in conventional cells (without extender) if an anode:cathode capacity ratio greater than 1:1 were to be used, as calculated using the Zinc and MnO₂ capacity values detailed above in this invention. An electrochemical cell including the extender has a cell discharge capacity greater than that of an otherwise identical cell containing primary active material in place of the extender.

Furthermore, the extender prevents excessive gassing that would be typically encountered in a cell with an anode to primary cathode electrochemical balance ratio of greater than 1:1 during over-discharge and when the cell goes into voltage reversal. Reduced gassing improves reliability of cells in a series string, and reduces the likelihood of voltage reversal and decrimping in the event of premature failure of a battery in the string.

Use of the cathode extender material allows use of an increased anode-primary cathode capacity ratio compared to conventional cells, thus increasing the electrolyte amount in the cell (and hence water) available to the MnO₂ in the cathode. This can significantly improve the discharge efficiency of MnO₂, as compared to conventional cells, without the disadvantage of cell gassing. It will be appreciated that as the discharge efficiency of the primary cathode active material increases, the amount of cathode required decreases, thereby freeing up space inside the cell for additional active material or extender material as desired.

Relatedly, if the total anode volume is increased, then the cathode volume (hence, mass) is reduced to fit in the available cell volume. In a standard bobbin design round cell, the cathode inner diameter will then necessarily have to be larger, creating a higher cathode active surface area (due to the increased diameter). This also benefits the cathode discharge efficiency by reducing the cathode current density during discharge.

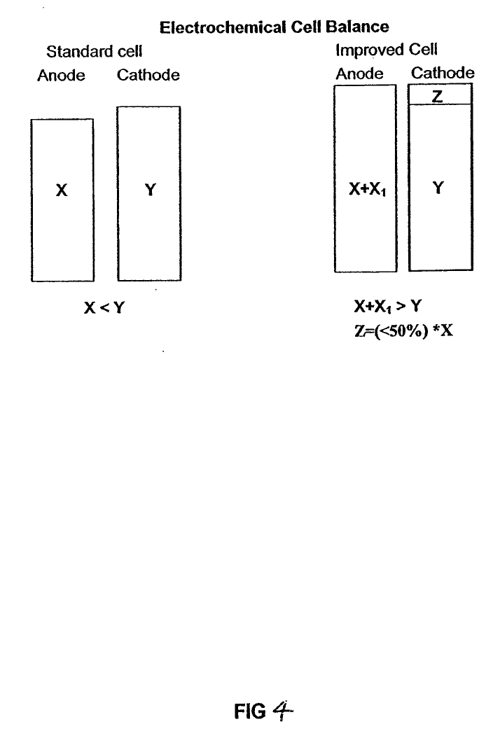

Referring to FIG. 4, the electrochemical balance of a conventional cell and a cell including an extender in accordance with at least one aspect of the present invention is illustrated. In FIG. 4, X represents the electrochemical capacity of the anode ((mAh/g)*g) and Y represents the electrochemical capacity of the primary cathode active material. As noted above, a conventional cell is anode-limited and is balanced to have excess cathode capacity; X is less than Y. In keeping with certain aspects of the present invention, the inclusion of a cathode extender Z enables additional anode capacity to be incorporated into the cell design. This is represented as an addition of electrochemically active anode capacity (X₁) to the conventional anode capacity X. This design allows substantially all of the primary cathode material Y to be used, since X+X₁>Y, whereas the overall electrochemical balance of the cell remains anode-limited, since X+X₁≦Y+Z.

In general, the extender may be located anywhere in the so long as it is in electronic contact with the positive terminal or the primary cathode material. It may therefore be blended with the primary cathode material, or be separated from it. In some instances, it may be desirable to keep it separate from the primary active material. By way of example, in a standard Zn/MnO₂ cell, the MnO₂ has a density of 4.5 g/cc, consumes two moles of water per mole of MnO₂, and incorporates protons into its structure to yield MnOOH (a poor electronic conductor and a material of lower density than the MnO₂). The need for extra water in the cell for the cathode reaction limits the amount of zinc that can be used, resulting in relatively low volumetric energy density. The EMD also has a sloping discharge curve.

On the other hand, copper oxide (CuO) which has a density of approximately 6.3 g/cc, consumes half the water in the first electron discharge compared to MnO₂, shows less volume expansion, has a relatively flat discharge curve, and provides high volumetric energy density in a cell. In a cathode that comprises a suitable percentage of EMD (say, 80-90% of total cathode active material by weight) and 10-20% CuO extender by weight, the EMD, which has an initially high operating voltage but a rather sloping discharge curve, discharges first, followed by the CuO, with a relatively sharp transition between them. In a cathode containing a physical mixture of the two, performance of the CuO portion of the cathode deteriorates as MnO₂ content increases, presumably for the following reasons. In such a cathode, the CuO discharge reaction takes over after the MnO₂ discharges its first electron. However, insufficient electrolyte is available to the CuO at this stage, for efficient reaction, causing mass transfer polarization. The MnO₂ volume expansion can also separate the CuO particles from themselves and from the conducting material (graphites) that is usually provided in the cathode. The conducting material can be natural or synthetic graphite, and further can include expanded graphite as appreciated by one having ordinary skill in the art. The effect of the initial MnO₂ discharge reaction is an increase of the ohmic resistance in the cathode, resulting in a further loss in voltage. The net effect of these processes is that the CuO material operates at a significantly lower voltage than it otherwise would when discharged by itself.

Certain aspects of the present invention therefore seek to mitigate the detrimental effects of dissimilar discharge behaviors by optionally providing in the cell a primary cathode and an extender in separate layers or tablets (or in separate layers that can comprise mixtures of oxides), or in a separate location in the cell, such that the extender material is able to discharge efficiently, as close as possible to its inherent reduction potential.

In a flat (prismatic) battery where the cathode may be in disk form, the active materials can be in stacked annular layers one over the other, concentric rings, or as adjacent arcuate segments (e.g., semicircular segments) one within the other as shown in FIG. 5. It should be appreciated that at least one of the layers can comprise the extender material, while the remaining layers can comprise the primary cathode active material. Alternatively, at least one of the layers can include a mixture of the extender material and primary cathode active material.

For a cylindrical battery configuration, which uses an annular cylindrical cathode in a can, either pressed externally and inserted as multiple hollow cylinders, also referred to as “tablets,” or fabricated in-situ in the can, the same concept can be used to keep the materials separated as shown in FIG. 6. The materials are in physical and electronic contact, but are not mixed or blended together. However, depending on the amount of extender desired, one of the cathode tablets could contain all of the extender and some primary active material, while the remaining tablets would only contain the primary active material.

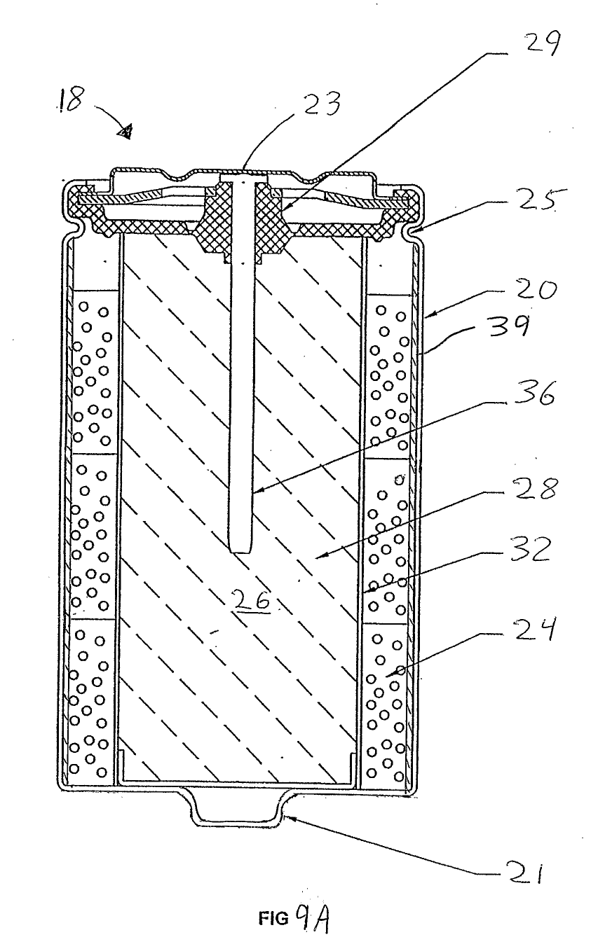

Further related cell configurations having advantage in the manufacturing process are also contemplated. For example, in the case of an alkaline Zn/MnO₂ cell, an extender is included in the cell at a location separate from the primary cathode material (i.e., the extender does not form part of the cathode), such that the weight of the EMD is greater than the weight of the extender material as illustrated in FIG. 8.

Referring to FIG. 7A, the extender material can be provided in a separate tablet form and occupy a portion of the can at selected locations within the cell, for instance proximal to the negative cell terminal 23. Alternatively, as illustrated in FIG. 7B, a tablet comprising extender material may be located near the negative end of the cell, towards the middle of the cell, or near the positive end of the cell. Alternatively still, more than one tablet comprising the extender material may be included, either adjacent the other extender tablet(s) or not (for example separated by a cathode tablet).

When the extender comprises a material that can corrode and generate anode-fouling species which, if allowed to travel to the anode, can negatively impact battery performance, a separate barrier material 35 can be provided, that can effectively limit the migration of anode-fouling soluble species. Suitable barrier materials include cellulosic films like cellophane, polyvinyl alcohol (PVA_) films, modified or cross-linked PVA films, laminated combinations, or suitable hybrids of such films and the like. Another such polymer is ethyl vinyl acetate (EVA) emulsion, that contains vinyl acetate monomers, vinyl acetate-ethylene copolymers and vinyl acetate polymers that can be used as films, or coated on non-woven separator materials to effectively limit migration of anode fouling soluble species. The barrier material 35 isolates the cathode extender from the anode and thus minimizes anode fouling. If the extender material is located as shown in FIGS. 7A and 7B, or is blended in with the primary cathode material as in FIG. 6, the entire tubular separator 32 can comprise a barrier material that effectively limits migration of the anode-fouling soluble species. Alternatively, a conventional separator 32 (spiral, convolute, cross-placed) can be provided in combination with a barrier separator 35 as illustrated in FIG. 7A. Such a separator system can benefit from a seam seal and a bottom seal to prevent migration of the anode-fouling species around the edges of the separator.

Alternatively, referring to FIG. 8, the extender 33 can at least partially fill the nubbin 21 and can further extend across the cell at a location proximal to the positive terminal. In this embodiment a barrier separator material 35 extends across the anode-facing surface of the extender 33 and can be provided, if desired, in combination with a conventional separator 32 as illustrated. In FIG. 8, the use of a barrier separator layer would also advantageously obviate the need for any seam and bottom seal for the tubular separator between the anode and the primary cathode material that may be desirable in the embodiments shown in FIGS. 6 and 7 when the extender comprises a material that can generate anode-fouling soluble species. The remainder of the cathode then can be in the form of conventional cylindrical cathode tablets 24 with a conventional porous cylindrical (spiral, convolute, cross-placed) separator 32.

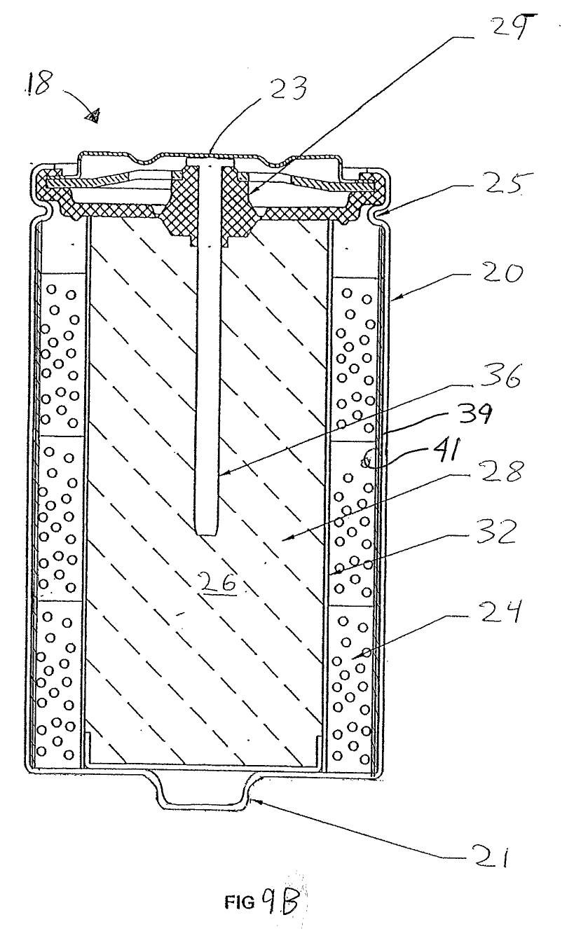

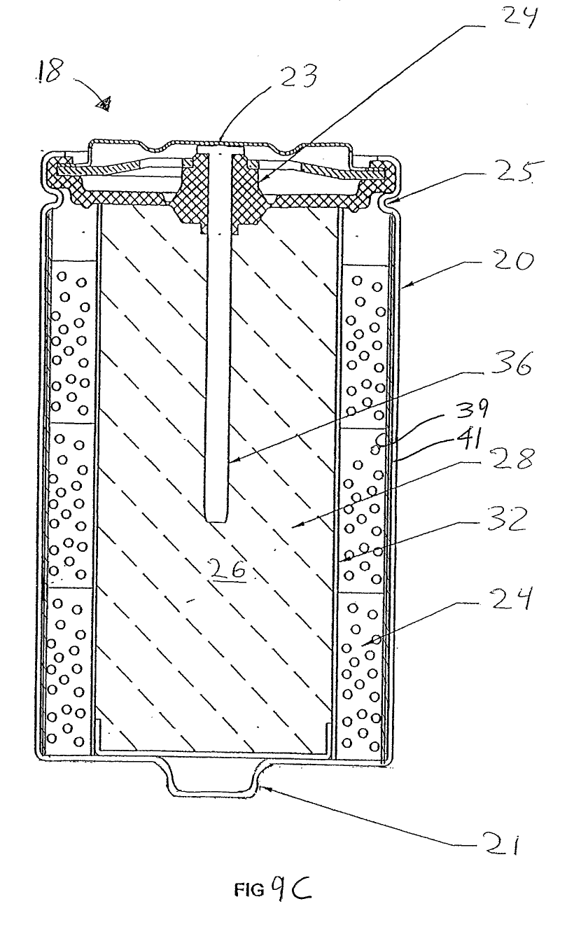

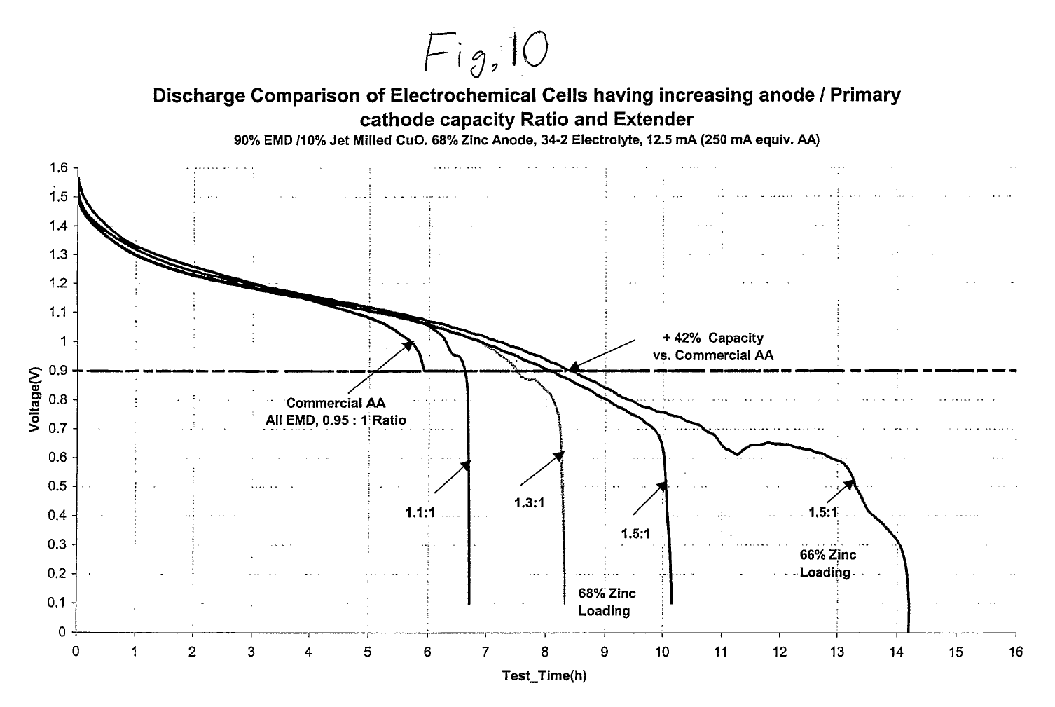

Alternatively, referring now to FIG. 9A, the cell 18 can include a layer 39 that includes extender material combined with a conducting agent (e.g. carbon black, graphite powders or fibers, metal particles or fibers, etc) and is coated on a portion of the inside surface of the battery container 20. Conventional present day alkaline battery cans can include a carbon coating on the inside surface of the battery container to improve the cathode-to-can contact and reduce the resistance of the cathode and thereby improve battery performance particularly at high current drains. Replacing such a carbon coating with a layer that includes the extender combined with the conducting agent can provide significant manufacturing flexibility and significantly reduce battery manufacturing cost. Alternatively, layer 39 (which can include the extender material mixed with a conducting agent) can be disposed between a conventional carbon coating 41 and the container 20 as illustrated in FIG. 9B. Alternatively still, layer 39 can be disposed at the inside surface of the conventional carbon coating as illustrated in FIG. 9C. Layers 39 and 41 can be sprayed in a variety of ways or otherwise coated in any manner understood by one having ordinary skill in the art.

In a typical manufacturing process, separate toroidal cathode tablets are fabricated in tabletting equipment before being inserted into the battery can. Multiple tablets are inserted into the cans until the required height is obtained. Such a process lends itself very well to the use of separate tablets of different materials. Accordingly, it is envisioned that the ratio of materials A to B can be varied depending on the amount of extender desired. Likewise, the number of such tablets can also be varied depending on the application.

Several approaches to increasing the anode:primary cathode capacity ratio of, and rebalancing, an alkaline cell are contemplated. In a first embodiment, wherein the anode and cathode volumes are fixed (and can be conventional), the alkaline cell includes an anode having more zinc mass per unit of anode volume than in conventional cells, thereby providing greater electrochemical discharge capacity to the cell over a wide range of discharge rates. The other components of the gelled zinc anode can be conventional and can comprise electrolyte, gelling agents, surfactants, and the like.

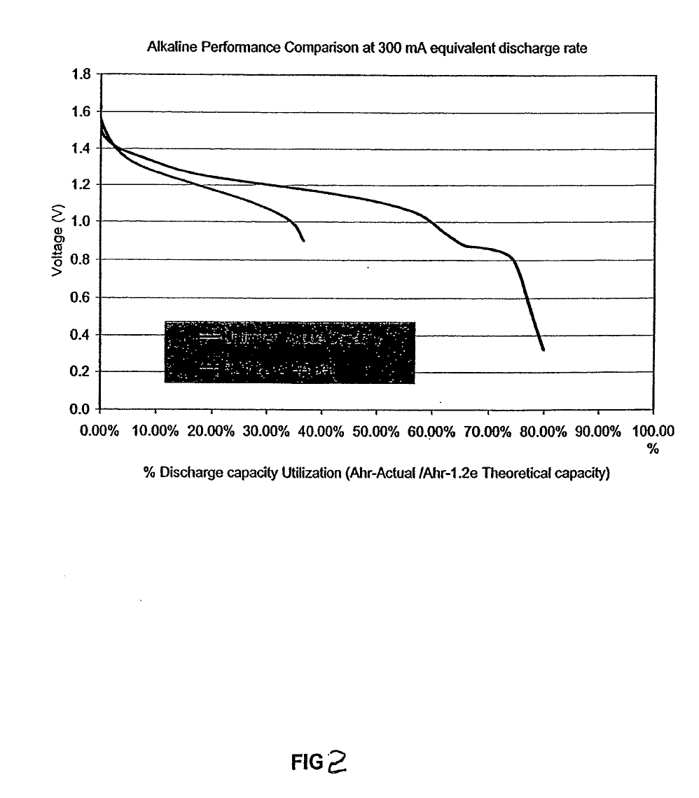

In a second embodiment, the anode:primary cathode capacity ratio can be increased from the current industry standard of below approximately 1:1, to as high as about 1.5:1 by increasing volume available for the anode in accordance with certain aspects of the present invention. In this second embodiment, the increased anode capacity and the resulting increased water:primary cathode molar ratio combine to achieve a greater anode and cathode discharge efficiency and hence, cell capacity. Without intending to be limited by theory, it is believed that the presence of more electrolyte (and hence more water) in the cell enabled by the higher anode amount favors primary cathode discharge by improving mass transport, thereby increasing primary cathode discharge efficiency as shown in FIG. 2, even though less of the primary cathode active material may be present than in a conventional cell having a conventional cell balance. As a result, significant capacity increase can be obtained during discharge of the cell at typical standard discharge rates with the endpoint of 1B or lower.

If desired, the barrier separator 35 disposed between the extender material 33 and the anode 26 can effectively limit the migration of the generated anode-fouling soluble species, such as silver species, copper species, and/or sulfur species, from the extender 33 into the anode compartment 28 while permitting migration of hydroxyl ions and water. Further, the cathode 24 or extender 33 or both can include an agent that reduces or prevents ionic species from migrating from the cathode toward the anode. Agents such as polyvinyl alcohol, activated carbon, various clays, and silicates such as Laponite and the like have shown an ability to adsorb or block ionic species.

### EXAMPLES

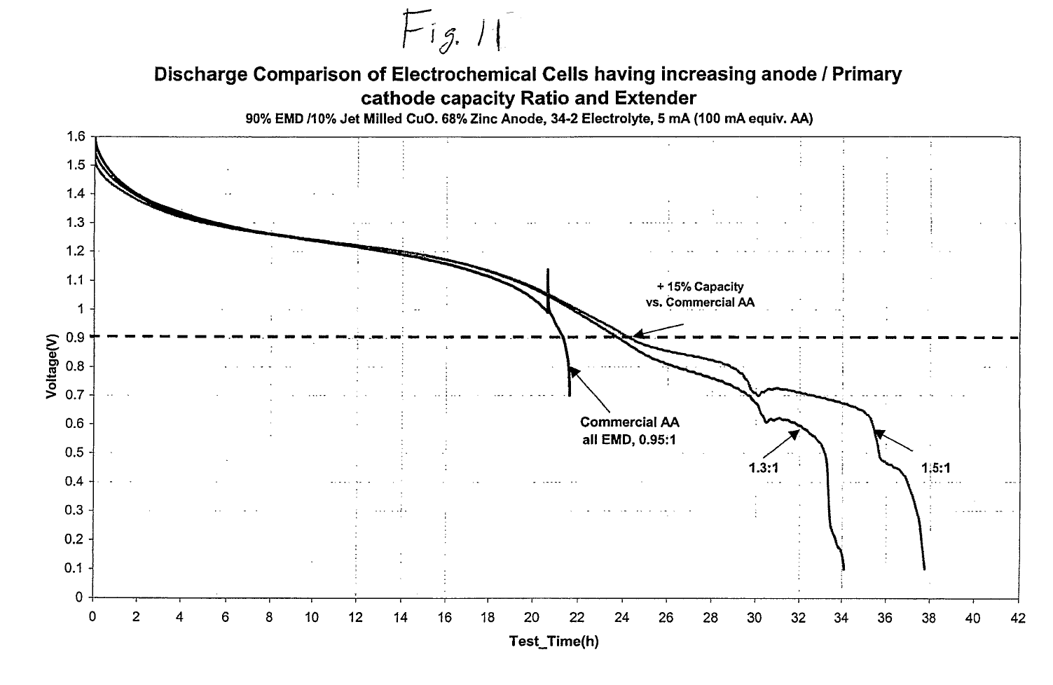

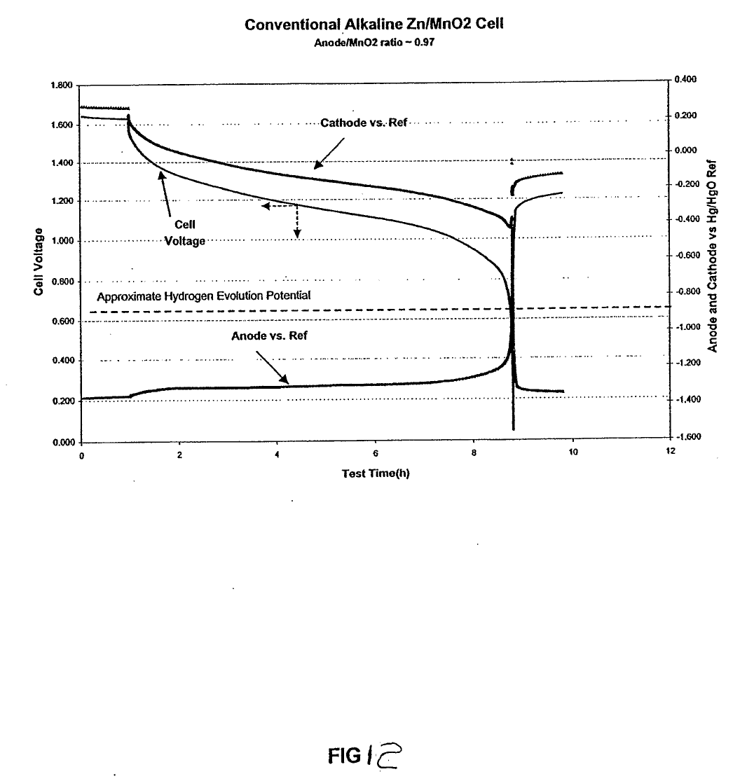

FIG. 10 shows the discharge behavior at 12.5 mA continuous (250 mA equivalent AA) current of alkaline cells having a cathode containing 90% EMD and 10% jet-milled CuO (as extender), where the weight percent of CuO was measured as a percentage of the total cathode active material. A commercial Zn/MnO₂ cell (Rayovac) discharge curve is also shown for comparison. It is seen that to a 0.9V cut-off, up to 45% increase in discharge capacity can be obtained by increasing the anode/primary cathode capacity ratio in combination with a lower Zinc loading in the anode gel. The commercial cell with an anode-limited design and having a capacity ratio of about 0.95:1 dies abruptly, as is shown by the precipitous drop in cell voltage. Many devices continue to operate even below 0.9V, hence the batteries including an extender can provide over 50% increased capacity. The presence of the extender extends the low voltage discharge significantly, preventing voltage from going low enough to generate gas. The effect is most clearly seen at lower anode loading (e.g., 66% vs. 68% Zinc loading) and lower discharge rates as seen in Example 2 (FIG. 11) where a lower current was used. Design optimization can further enhance the cathode capacity and extender performance.

FIG. 11 shows the discharge behavior at 5 mA (100 mA equivalent AA) current of alkaline cells having a cathode containing 90% EMD and 10% jet-milled CuO (as extender), where the weight percent of CuO was measured as a percentage of the total cathode active material. Compared to a commercial AA with a anode/cathode capacity ratio of about 0.95:1, up to 15% capacity increase can be obtained to 0.9V. At lower voltages, the benefit is 30-50%. The commercial cell having approximately 0.95:1 ratio again shows an abrupt voltage drop and no capacity below 0.8V. Once again, in the presence of the extender, discharge is significantly prolonged.

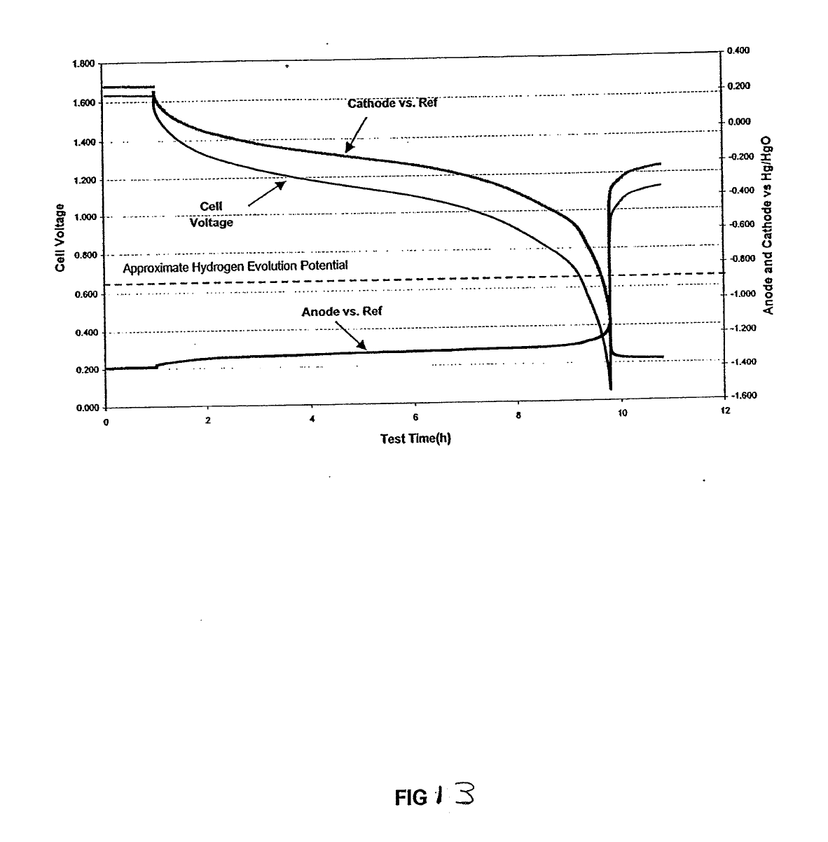

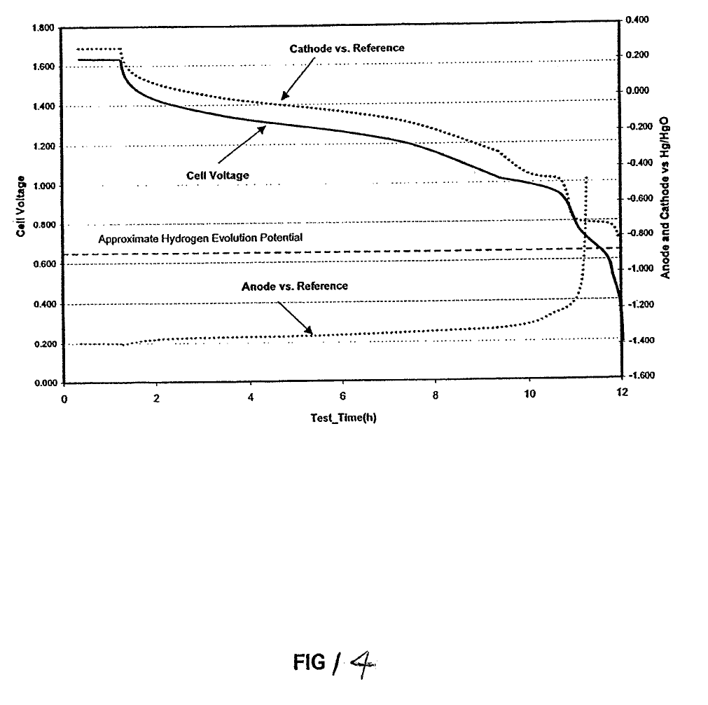

FIGS. 12 to 14 show the effect of various scenarios in a Zn/MnO₂ alkaline AA cell having a Hg/HgO Reference Electrode. FIG. 12 shows the anode and cathode voltages of a LR6 (AA) cell having a conventional anode:MnO₂ capacity ratio vs. a Hg/HgO reference electrode. The left axis shows the cell voltage. Since the cell is anode limited, the anode voltage (vs. Reference) rapidly increases upon over-discharge beyond 8.5 hrs and the cathode voltage is approximately 0.45V. FIG. 13 shows that increasing the Anode:MnO₂ ratio to approximately 1.2 even without an extender would significantly increase run time of the battery. However, it is important to note that the cathode voltage (vs. Reference) drops to about −1.0 V (unlike in the previous example) past the threshold potential for hydrogen evolution because of limited cathode in this case. This will result in rapid, significant hydrogen evolution on the cathode and cathode current collector (can wall) surface and cause rupture of the seal, leading to a potential leakage of electrolyte or explosion of the battery.

FIG. 14 schematically shows that in the presence of an electroactive cathode extender material like CuO, which has a high volumetric and gravimetric energy density, the extender discharges in multiple steps, resulting in a significant increase in cathode discharge capacity. The CuO discharge mechanism is complex, but it is understood to discharge in two steps:

Step 1: 2CuO+2e+H₂O→Cu₂O+2OH⁻

Step 2: Cu₂O+2e+H₂O→2Cu+2OH⁻

The cell, as illustrated in FIG. 14, prevents the cathode voltage from going below the threshold for hydrogen evolution, thereby prolonging the discharge of the excess zinc and consuming excess electrolyte before the electrolyte gas evolution potential is reached. In this manner, at the end of life, the cell is as benign as any conventional alkaline cell but with a much higher capacity. The battery depicted in FIG. 14 had an anode:MnO₂ discharge capacity ratio of about 1.2:1.

In view of the above, it will be seen that the several advantages of the invention are achieved and other advantageous results attained. As various changes could be made in the above processes and composites without departing from the scope of the invention, it is intended that all matter contained in the above description and shown in the accompanying drawings shall be interpreted as illustrative and not in a limiting sense.

1. An electrochemical cell comprising:
a container defining a positive cell terminal end and a negative cell terminal end;
a cathode disposed in the container and including a primary active material;
an extender different from the primary active material and present in an amount no greater than that of the primary active material;
an anode including an anode material disposed in the container adjacent the cathode; and
at least one separator disposed between the anode and cathode, and further disposed between the anode and extender.

2. The electrochemical cell as recited in claim 1, wherein the cell has a discharge capacity greater than that of an otherwise identical cell containing primary active material in place of the extender.

3. (canceled)

4. The electrochemical cell as recited in claim 1, wherein the primary active material comprises manganese dioxide.

5. (canceled)

6. The electrochemical cell as recited in claim 1, wherein the extender has a discharge voltage lower than an initial discharge voltage of the primary active material.

7. The electrochemical cell as recited in claim 1, wherein the extender includes an oxide of copper.

8. The electrochemical cell as recited in claim 1, wherein the extender includes at least one of a metal, a sulfur-containing material, a hydroxide, and a salt.

9-11. (canceled)

12. The electrochemical cell as recited in claim 1, wherein the extender comprises a material identified generally by M_{X}Cu_{y}O_{Z}, wherein:
M is any element capable of producing mixed oxide compounds or complexes;
1≦x≦5;
1≦y≦5; and
1≦z≦20.

13. The electrochemical cell as recited in claim 12, wherein M is selected from the group consisting of Mn, Ni, Co, Fe, Sn, V, Mo, Pb, and Ag.

14. The electrochemical cell as recited in claim 12, wherein the copper based mixed oxide material further comprises an additional metal “A” identified in a compound AM_{X}Cu_{y}O_{z}.

15. The electrochemical cell as recited in claim 14, wherein “A” is selected from the group consisting of Li, Na, K, Rb, Cs, Ca, Mg, Sr and Ba.

16. The electrochemical cell as recited in claim 1, wherein the extender has a specific discharge capacity at least as high as that of the primary active material.

17-18. (canceled)

19. The electrochemical cell as recited in claim 1, having an anode: primary cathode capacity ratio greater than 0.98:1.

20-23. (canceled)

24. The electrochemical cell as recited in claim 1, having an anode capacity/cell internal volume ratio greater than 0.5 Ah/cc.

25-26. (canceled)

27. The electrochemical cell as recited in claim 1, wherein the extender is disposed in the cathode.

28. (canceled)

29. The electrochemical cell as recited in claim 1, wherein the extender is disposed proximal to at least one of the positive cell terminal end and the negative cell terminal end.

30. The electrochemical cell as recited in claim 1, wherein, in the presence of alkaline electrolyte, the extender generates anode-fouling species soluble in the electrolyte and capable of migrating toward the anode.

31. The electrochemical cell as recited in claim 30, further comprising an agent that reduces anode fouling by the soluble species with respect to an identical cell without the agent.

32-37. (canceled)

38. The electrochemical cell as recited in claim 31, wherein the agent is selected from the group consisting of polyvinyl alcohol, activated carbon, and a silicate.

39-40. (canceled)

41. The electrochemical cell as recited in claim 1, wherein the primary active material comprises at least one of an oxide and a hydroxide of at least one of nickel, lead, and silver.

42. The electrochemical cell as recited in claim 1, wherein a layer comprising the extender and a conducting agent is disposed between the cathode and the container.

43-44. (canceled)

45. The electrochemical cell as recited in claim 1, further comprising an alkaline electrochemical cell.

46. An electrochemical cell comprising:
a container defining a positive cell terminal end and a negative cell terminal end;
a cathode disposed in the container and including a primary active material;
an extender different from the primary active material, wherein the extender has a discharge voltage lower than an initial discharge voltage of the primary active material.

47. The electrochemical cell as recited in claim 46, wherein the cell has a discharge capacity greater than that of an otherwise identical cell containing primary active material in place of the extender.

48. (canceled)

49. The electrochemical cell as recited in claim 46, wherein the primary active material comprises manganese dioxide.

50. (canceled)

51. The electrochemical cell as recited in claim 46, wherein the extender includes an oxide of copper.

52. The electrochemical cell as recited in claim 46, wherein the extender includes at least one of a metal, a sulfur-containing material, a hydroxide, and a salt.

53-55. (canceled)

56. The electrochemical cell as recited in claim 46, wherein the extender has a specific discharge capacity of at least as high as that of the primary active material.

57-58. (canceled)

59. The electrochemical cell as recited in claim 46, having an anode: primary cathode capacity ratio greater than 0.98:1.

60-63. (canceled)

64. The electrochemical cell as recited in claim 46, having an anode capacity/cell internal volume ratio greater than 0.5 Ah/cc.

65-163. (canceled)

164. An electrochemical cell comprising:
an anode;
a cathode; and
a separator disposed between the anode and cathode;
wherein the anode has a capacity of at least 0.5 Ah per cubic centimeter of cell internal volume.

165-259. (canceled)
